(19) United States
(12) Patent Application Publication
(10) Pub. No.: US 2026/0233038 A1
(43) Pub. Date: Aug. 13, 2026

(54) Autonomous Firefighting System with Coordinated Drone Fleet

(71) Applicant: Adam Denoto, Brook Park, OH (US)

(72) Inventor: Adam Denoto, Brook Park, OH (US)

(21) Appl. No.: 19/321,535

(22) Filed: Sep. 8, 2025

Related U.S. Application Data
(60) Provisional application No. 63/756,324, filed on Feb. 10, 2025.

(51) Int. Cl. A62C 3/07; A62C 3/02

(52) U.S. Cl. CPC A62C 3/07; A62C 3/02

(57) ABSTRACT

A wildfire rapid response and containment system utilizing a coordinated fleet of autonomous aerial drones is disclosed. Each drone comprises a lightweight frame, onboard tanks for fire-retardant materials, a 360-degree camera, adjustable spray nozzles, GPS and communication modules, and an artificial intelligence (AI) copilot configured for autonomous navigation, obstacle avoidance, and real-time fire suppression decisions. The drones are wirelessly connected to a control server that includes a fleet coordinator, fire map engine, and distributed suppression module for assigning fire zones and managing swarm behavior. A refilling/replenishing base provides automatic replenishment of fire-retardant materials and recharging of drone power supplies. The invention enables continuous, scalable, and low-risk suppression of wildfires in remote or hazardous terrain through synchronized multi-drone operations and dynamic fire zone management.

### CROSS REFERENCE TO RELATED APPLICATION

The present application claims priority to, and the benefit of, U.S. Provisional Application No. 63/756,324 which was filed on Feb. 10, 2025, and is incorporated herein by reference in its entirety.

### FIELD OF THE INVENTION

The present invention generally relates to autonomous aerial systems and wildfire suppression technologies. More specifically, the present invention relates to an intelligent drone-based firefighting apparatus configured to detect, contain, and extinguish wildfires in a rapid and coordinated manner. The invention comprises a multirotor unmanned aerial vehicle (UAV) equipped with onboard fire-retardant tanks, a 360-degree environmental camera, adjustable spray nozzles, and an artificial intelligence (AI) copilot system. The drone is further integrated with GPS navigation and communication modules, enabling real-time coordination with a centralized control server. The onboard nozzle system is configured to dispense suppressant (i.e., fire-retardant chemical) materials in a direct or dispersed spray mode based on environmental conditions. The AI copilot manages flight navigation, obstacle avoidance, and real-time suppression strategy. Accordingly, the present disclosure makes specific reference thereto. Nonetheless, it is to be appreciated that aspects of the present invention are also equally applicable to other like applications, devices, and methods of manufacture.

### BACKGROUND

By way of background, wildfires are one of the most dangerous and rapidly escalating forms of natural disaster, capable of causing widespread destruction to forests, wildlife, human life, and property. The wildfires are driven by wind, dry vegetation, and fluctuating terrain conditions. Once active, wildfires can quickly escalate and become beyond the reach of conventional firefighting methods, especially in remote or rugged regions.

Traditional firefighting efforts including human personnel, ground-based fire trucks, and manned aerial vehicles are inadequate for wildfires. Human firefighters are frequently placed in extreme danger, especially when operating near fast-moving fire lines or in inaccessible terrain. Need to transport crews and equipment to the affected zones cause delays which result in exponential fire growth and environmental loss. Moreover, terrain challenges such as mountainous regions, dense forests, or areas with poor infrastructure further complicate rapid deployment of firefighting equipment. Accordingly, there is a need for an autonomous and terrain-independent firefighting system capable of operating without endangering human life.

Therefore, there exists a long-felt need in the art for a wildfire containment system that provides a faster, safer, and more scalable response to active fire zones. There remains a need for a firefighting apparatus that eliminates or minimizes human risk during continuous and autonomous wildfire suppression. Further, there is a need for a system that enables intelligent, coordinated deployment of aerial firefighting units capable of navigating complex environments using real-time data. Additionally, there is a need for a drone-based system that enables for dynamic coordination across a swarm of aerial vehicles with capabilities for environmental awareness, target prioritization, and automatic replenishment. Finally, there exists a need for a fully integrated wildfire suppression solution that combines fire detection, autonomous response, suppression execution, and real-time system control without dependence on manned aircraft or ground vehicles.

The subject matter disclosed and claimed herein, in one embodiment, comprises a wildfire drone rapid response and containment system that includes a fleet of autonomous aerial drones configured for vertical takeoff and landing. Each drone is equipped with onboard tanks for storing fire-retardant or water, a dispensing nozzle, and a 360-degree environmental camera. The drones include artificial intelligence systems that support real-time fire suppression decisions, GPS-based navigation, and collision avoidance. A control server wirelessly communicates with each drone to manage fleet coordination, fire mapping, and suppression zone allocation. A refilling/replenishing base is included to automate tank refills and battery recharging, enabling drones to operate continuously for extended wildfire containment.

In one embodiment, the drone includes a main tank and an auxiliary tank for dual-phase fire suppression, with each tank operably coupled to an electronically actuated spray nozzle. The 360-degree panoramic camera system provides situational awareness and supports terrain mapping, object avoidance, and coordinated swarm alignment. Each drone is powered by multiple propellers driven by independent motors, providing lift, thrust, and fine maneuverability in response to AI-generated flight paths. The drones exchange telemetry with a cloud-based or local control server, where incoming data is processed through a fleet coordinator and fire map engine. The server dynamically updates fire suppression assignments, ensuring the most efficient coverage based on temperature data, wind patterns, and fire spread predictions.

In this manner, the wildfire containment system of the present invention addresses long-standing deficiencies in traditional fire suppression methods by offering a scalable, autonomous, and intelligently coordinated aerial firefighting solution. The system reduces risk to human firefighters while enhancing response time, fire containment accuracy, and operational efficiency. The drone fleet, combined with AI-driven coordination and automatic replenishment, enables for rapid and sustained suppression efforts even in remote or rugged locations.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fire rapid response drone device. The device comprises a drone frame made of lightweight and fire-resistant materials, at least one tank is configured to store a fire-retardant substance, a nozzle is coupled to the at least one tank, the nozzle is configured to dispense the fire-retardant substance in a direct or dispersed spray pattern, a 360-degree camera is configured to provide environmental visibility and obstacle detection, an onboard artificial intelligence (AI) system is configured to perform autonomous navigation, real-time fire suppression decisions, and flight path recalculations, a plurality of propellers are included for vertical lift and maneuverability, and a plurality of motors, each motor is operably connected to a corresponding propeller to generate rotational motion.

In another embodiment, a wildfire drone rapid response and containment system is disclosed. The wildfire drone rapid response and containment system comprises a plurality of fire rapid response drone devices, each drone device comprises a GPS module, communication module, fire suppressant tank, and an AI copilot module, a control server is configured to communicate with the plurality of drone devices via a network, the control server comprises a fleet coordinator configured to assign fire suppression zones based on fire dynamics and drone status, a fire map engine is configured to compile telemetry data from the plurality of drone devices to generate a real-time topographical fire map, a distributed target suppression module is configured to divide the fire zone into a plurality of dynamically assigned sectors and instruct the drone devices to perform synchronized suppression actions, and refilling/replenishing base is configured to automatically replenish fire-retardant tanks and recharge the drone devices.

In one embodiment, a method for autonomous wildfire suppression is described. The method includes the steps of detecting a wildfire or heat anomaly via a thermal or environmental monitoring system, launching a plurality of autonomous drone devices from a refilling/replenishing base or control station, establishing communication between each drone device and a control server, coordinating in-flight operation of the drone devices using onboard AI copilots and a central fleet coordinator, dispensing fire-retardant material over designated fire zones using adjustable nozzles, returning the drone devices to the refilling/replenishing base upon depletion of fire-retardant or power, and automatically replenishing the drone devices and re-deploying them into the fire zone.

In yet another embodiment, a system for coordinating autonomous firefighting drones using artificial intelligence is disclosed. The system comprises an AI copilot module installed in each drone, the AI copilot module is configured to autonomously navigate to GPS-designated fire zones, perform obstacle avoidance based on sensor and visual input, identify fire hotspots using onboard thermal imaging or video feeds, and activate fire suppressant nozzles based on proximity and fire characteristics.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of fire rapid response drone device of the present invention in accordance with the disclosed structure;

FIG. 2 illustrates a schematic view of the wildfire drone rapid response and containment system formed using at least one wildfire containment drone in accordance with one embodiment of the present invention;

FIG. 3 illustrates an exemplary method for autonomous wildfire suppression utilizing a coordinated fleet of drones of the wildfire drone rapid response and containment system in accordance with one embodiment of the present invention;

FIG. 4 illustrates a perspective view of a plurality of firefighting drone devices in active wildfire suppression operations in accordance with the disclosed structure; and

FIG. 5 illustrates a perspective view of another embodiment of the wildfire containment drone in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a wildfire containment system that provides a faster, safer, and more scalable response to active fire zones. There remains a need for a firefighting apparatus that eliminates or minimizes human risk during continuous and autonomous wildfire suppression. Further, there is a need for a system that enables intelligent, coordinated deployment of aerial firefighting units capable of navigating complex environments using real-time data. Additionally, there is a need for a drone-based system that enables dynamic coordination across a swarm of aerial vehicles with capabilities for environmental awareness, target prioritization, and automatic replenishment. Finally, there exists a need for a fully integrated wildfire suppression solution that combines fire detection, autonomous response, suppression execution, and real-time system control without dependence on manned aircraft or ground vehicles.

The present invention, in one exemplary embodiment, is a wildfire drone rapid response and containment system. The wildfire drone rapid response and containment system comprises a plurality of fire rapid response drone devices, each drone device comprises a GPS module, communication module, fire suppressant tank, and an AI copilot module, a control server is configured to communicate with the plurality of drone devices via a network, the control server comprises a fleet coordinator configured to assign fire suppression zones based on fire dynamics and drone status, a fire map engine is configured to compile telemetry data from the plurality of drone devices to generate a real-time topographical fire map, a distributed target suppression module is configured to divide the fire zone into a plurality of dynamically assigned sectors and instruct the drone devices to perform synchronized suppression actions, and refilling/replenishing base is configured to automatically replenish fire-retardant tanks and recharge the drone devices.

Reference will now be made in detail to the present preferred embodiments of the invention, examples of which are illustrated in the accompanying drawings. Wherever possible, the same reference numerals are used in the drawings and the description to refer to the same or like parts.

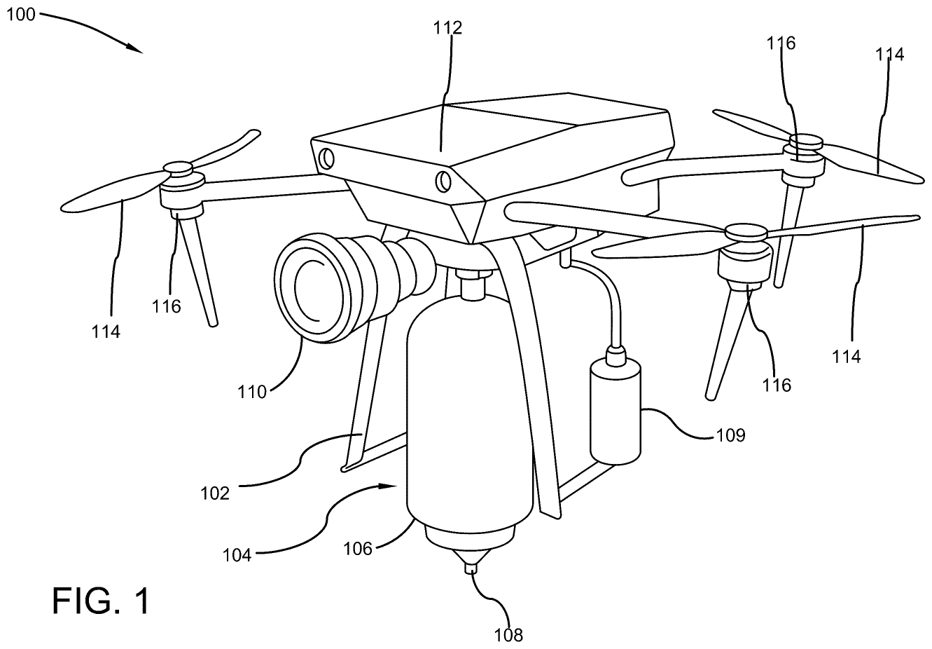

Referring initially to the drawings, FIG. 1 illustrates a perspective view of one potential embodiment of fire rapid response drone device of the present invention in accordance with the disclosed structure. The fire rapid response drone device 100 of the present invention is designed as an autonomous aerial firefighting device that works with a coordinated fleet of drones to detect, contain, and suppress wildfires. More specifically, the fire rapid response drone device 100 includes a drone frame 102 made of lightweight and durable materials such as carbon fiber or fire-resistant composite alloys. The fire rapid response drone device 100 is configured to vertical takeoff and landing to enable operation in rugged terrain without the need for runways. The fire rapid response drone device 100 preferably has a Type 1 classification and is designed for frontline wildfire operations and other large-scale fires.

The fire rapid response drone device 100 includes an onboard tank system 104 in the form of one or more tanks 106 for storing fire-retardant chemicals and/or water. The tank system 104 can include tanks of various sizes depending on the manufacturing requirements of the drone device 100. Each tank 106 includes a nozzle 108 for spraying and directing the fire-retardant chemical/water for fire suppression. The nozzle 108 can be adjusted for direct targeting or dispersed spraying and is automatically activated (i.e., autonomously actuated) when the wildfire containment drone 100 reaches a fire target location. An auxiliary tank 109 which is in the form of a pressurized canister is included in the fire rapid response drone device 100 and may help in pressurizing the tank 106. The auxiliary tank 109 may also store a secondary chemical agent to be used for extinguishing fire.

A 360-degrees camera 110 is integrated into the wildfire containment drone 100 and provides complete environmental visibility in horizontal and vertical planes. The camera 110 can be a spherical lens camera, dual-lens panoramic camera, or any other conventional camera compatible for aerial imaging. The camera 110 has a frame rate of more than 30 fps for real-time video feed. The camera 110 is adapted to map obstacles like trees, power lines, and other drones to support collision avoidance and adaptive pathfinding.

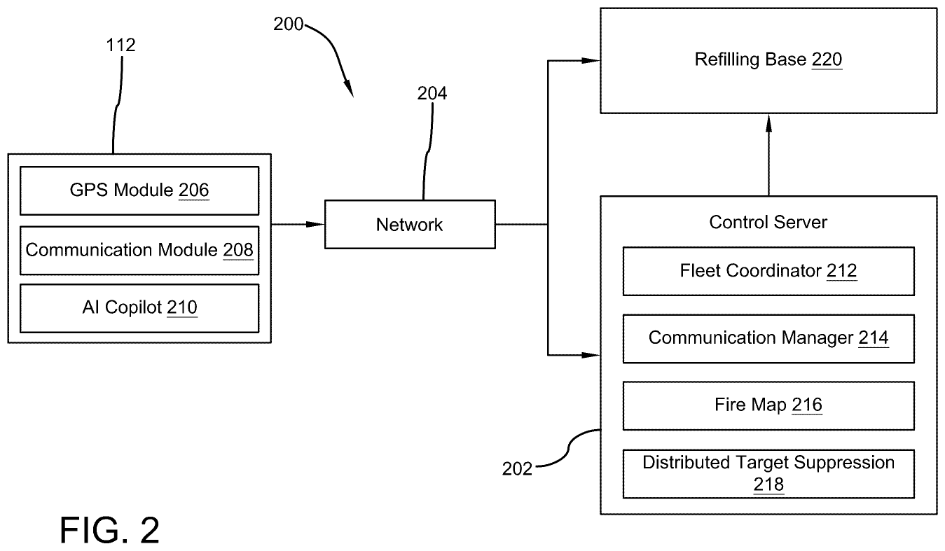

An onboard artificial intelligence (AI) system 112 is embedded in the wildfire containment drone 100. The onboard AI system 112 includes a plurality of electronic components as described in FIG. 2 and is configured to assist in location tracking of the wildfire containment drone 100. The AI system 112 also includes mechanism to synchronize with other drones to synchronize fire extinguishing attack patterns. The AI system 112 also helps in recalculation of path of the wildfire containment drone 100 based on wind change, fire spread, obstacles, and more.

A plurality of propellers 114 generate vertical lift that enables the fire rapid response drone device 100 to take off, hover, and maneuver in the air. The fire rapid response drone device 100 preferably has a multirotor configuration where the plurality of propellers 114 maintain balance and enable yaw, pitch, and roll control of the wildfire containment drone 100. Each propeller of the plurality of propellers 114 has a corresponding motor 116 for generating the rotational motion or torque in the propeller. The rotation in the motor 116 causes the corresponding propeller to rotate, generating airflow and lift.

FIG. 2 illustrates a schematic view of the wildfire drone rapid response and containment system formed using at least one wildfire containment drone in accordance with one embodiment of the present invention. In use, the wildfire containment drone 100 is wirelessly coupled with a control server 202 via a network 204 which can be a public network such as Internet or a private network. The control server 202 functions as a central coordination hub for coordinating flight patterns of a plurality of wildfire containment drones used for containing a large-scale fire such as wildfire.

Each wildfire containment drone 100 includes a GPS module 206 for real-time geolocation tracking and flight path adherence of the drone 100. The GPS module 206 provides real-time geographic location data to track the position of the drone 100. Further, the GPS module 206 may also integrate altitude and heading data for enhanced spatial awareness. A communication module 208 facilitates wireless communication between the drone 100 and the control server 202 via the network 204. The communication module 208 can support various communication protocols such as RF, LTE/5G, or satellite to provide connectivity in remote environments. An AI copilot 210 is an onboard artificial intelligence engine capable of making real-time autonomous decisions. The AI Copilot 210 provides autonomous navigation of the drone 100, obstacle avoidance, fire line detection, dynamic flight path correction, and localized fire suppression mechanism. The AI Copilot 210 may also analyze visual and thermal inputs received from onboard sensors such as camera 110 (i.e., visual monitor) and a heat gun (i.e., thermal monitor) to support autonomous decision-making.

The control server 202 includes a fleet coordination 212 that automatically allocates operational responsibilities to each drone unit within the drone swarm system 200 based on current fire dynamics, drone availability, battery levels, and suppressant (i.e., fire-retardant chemical) load or level. The fleet coordinator helps with efficient coverage and distribution of drones across active fire zones.

A communication manager 214 provides network communication with all the drone units of the system 200. All the communications between the communication manager 214 and each individual drone is encrypted and encoded with a unique identifier identifying the individual drone. The communication manager 214 may also be used to broadcast signals from the control server 202 for activating the drones for fire containment.

The control server 202 is configured to receive telemetry data such as GPS location, thermal imaging, video feeds, from the drones and the fire map engine 216 compiles incoming data from drones to generate a real-time topographical map of the fire. The map generated by the fire map engine 216 is used by both the fleet coordinator 214 and the AI copilots 210 to update drone routes and identify emerging hotspots.

A distributed target suppression module 218 divides the fire zone into a plurality of dynamically assigned sectors based on latitude and longitude details of the fire zone. The distributed target suppression module 218 orchestrates the behavior of each drone to collectively suppress the fire using optimal spray patterns and paths. The distributed target suppression module 218 also configures the direction of nozzle of each tank included in each drone for an effective fire suppression.

The system 100 includes a refilling/replenishing base 220 which serves as a physical hub for drone maintenance and recharging. The refilling/replenishing base 220 provides automatic refilling/replenishing of fire-retardant chemicals or water tanks carried by each drone, recharge or replacement of drone batteries or power cells, and exchange mission data with the control server 202 of each drone. In some embodiments, the refilling/replenishing base 220 can be mobile such as vehicle-mounted or air-dropped into a field.

In use, the drone device 100 is deployed into an affected fire zone. The AI Copilot 210 is guided by GPS Module 206 and is informed by communication from the control server 202 via communication module 208. The AI Copilot 210 autonomously navigates the drone device 100 to designated coordinates. Once reached the hotspot or target area, the drone device 100 executes or discharges suppression actions under the guidance of the distributed target suppression module 218. Also, when the fire-retardant or power levels of the drone device 100 reach a predefined threshold, the drone device 100 based on communication received from the fleet coordinator 212, returns to the refilling/replenishing base 220.

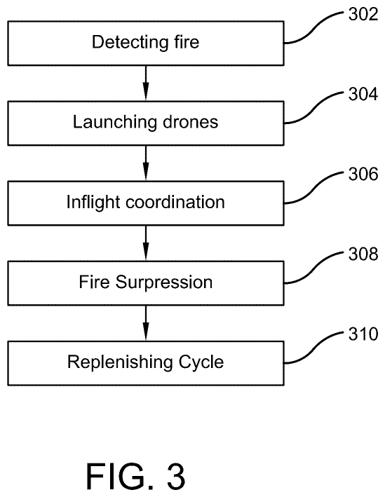

FIG. 3 illustrates an exemplary method for autonomous wildfire suppression utilizing a coordinated fleet of drones of the wildfire drone rapid response and containment system in accordance with one embodiment of the present invention. Initially, a wildfire or heat anomaly is detected by the control server 202 and can be detected using one or more detection means including but not limited to external early warning systems such as satellite feeds, real-time input from thermal imaging cameras or environmental monitoring systems integrated with the drones or server (Step 302). Then, designated number of drone devices are launched from the control server 202 or refilling/replenishing base 220 (Step 304). The drones are selected and dispatched based on factors such as proximity of the drones to fire zone, availability of retardant and battery charge. Further, on launch, each drone device initializes the GPS module 206, establishes network connectivity, and activates the AI Copilot 210 for autonomous flight and hazard assessment.

Thereafter, the deployed drones operate collaboratively during flight (Step 306). The AI Copilot 210 on each drone exchanges telemetry with the control server 202 via the communication module 208 over network 204 and may perform real-time positional adjustments, avoidance of aerial collisions, and fire spread prediction based on updates from the Fire Map 216.

In the next step, each drone initiates fire suppression using onboard tanks of fire-retardant or water (Step 308) and may use precision-based (for specific areas) or area-based (for blanket coverage) suppression. Finally, upon depletion of fire-retardant or power, the drones autonomously return to the refilling/replenishing base 220 (Step 310).

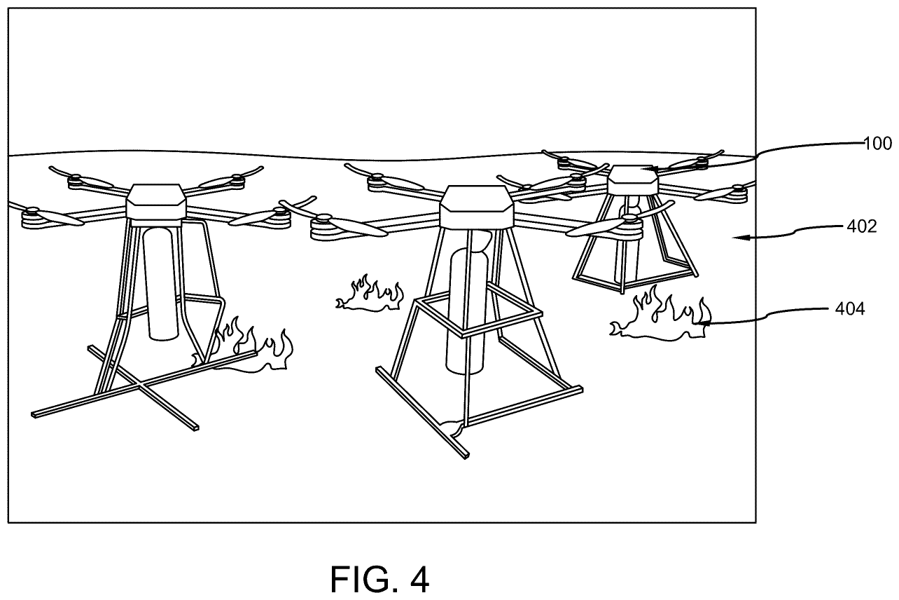

FIG. 4 illustrates a perspective view of a plurality of firefighting drone devices in active wildfire suppression operations in accordance with the disclosed structure. As illustrated, a plurality of drone devices 100 are positioned over an active wildfire zone 402, wherein the plurality of drone devices 100 function simultaneously to suppress flames 404 in a distributed and coordinated manner. The drone devices 100 use suppression patterns synchronously as described earlier in the disclosure.

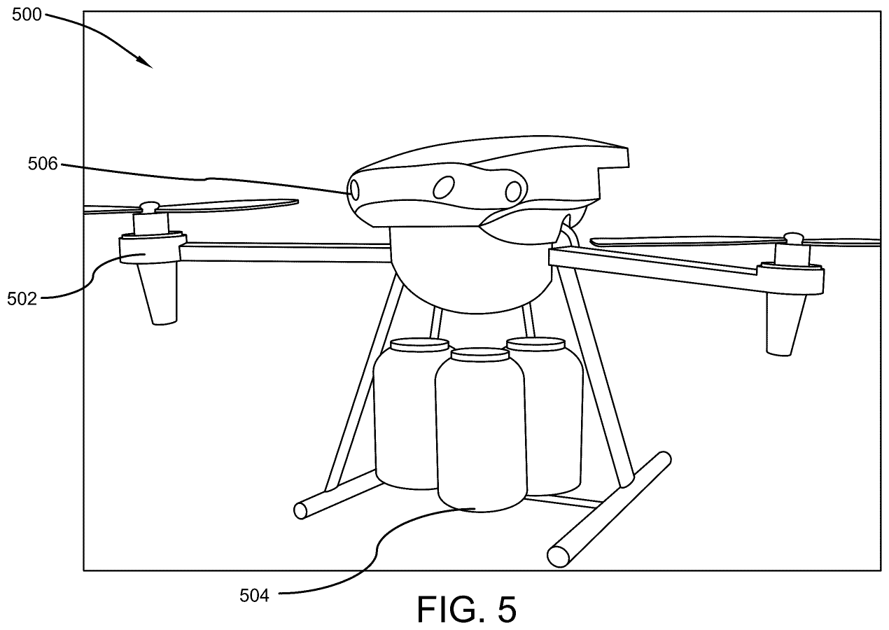

FIG. 5 illustrates a perspective view of another embodiment of the wildfire containment drone in accordance with the disclosed structure. In the present embodiment, the wildfire containment drone 500 is in hexacopter or quadcopter configuration with four or more propellers 502 and includes a plurality of fire-retardant material tanks 504. Each tank of the plurality of tanks 504 stores water, foam, or chemical retardants, and may be independently actuated for selective or combined dispensing.

The drone device 500 may include LIDAR or depth sensors for terrain mapping and obstacle avoidance 506 which can work with camera or other sensors which are described in FIG. 1. The drone device 500 may be supported by tubular landing gear providing clearance for ground-based refilling/replenishing operations and stable landing in uneven wildfire terrain.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “drone device”, “fire rapid response drone device”, “wildfire containment drone”, and “drone” are interchangeable and refer to the wildfire containment autonomous drone 100 of the present invention.

Notwithstanding the foregoing, the wildfire containment autonomous drone 100 of the present invention can be of any suitable configuration as is known in the art without affecting the overall concept of the invention, provided that it accomplishes the above stated objectives. One of ordinary skill in the art will appreciate that the wildfire containment autonomous drone 100 as shown in the FIGS. are for illustrative purposes only, and that many other configurations of the wildfire containment autonomous drone 100 are well within the scope of the present disclosure. Although the dimensions of the wildfire containment autonomous drone 100 are important design parameters for user convenience, the wildfire containment autonomous drone 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fire rapid response aerial device comprising:
an autonomous aerial firefighting device having a frame, a plurality of propellers, an onboard tank, a nozzle, a camera, and a fire-retardant chemical;
wherein said onboard tank containing said fire-retardant chemical for fire suppression;
wherein said nozzle directs a spray of said fire-retardant chemical;
wherein said nozzle autonomously actuated when said autonomous aerial firefighting device reaches a fire target location; and
further wherein said nozzle having an adjuster for direct targeting of said fire-retardant chemical.

2. The fire rapid response aerial device of claim 1 further comprising an auxiliary tank having a pressurized canister to supply pressure to said onboard tank.

3. The fire rapid response aerial device of claim 1 further comprising an auxiliary tank having a secondary chemical agent used for extinguishing fire.

4. The fire rapid response aerial device of claim 2, wherein said fire-retardant chemical is water.

5. The fire rapid response aerial device of claim 2, wherein said autonomous aerial firefighting device having at least another onboard tank.

6. The fire rapid response aerial device of claim 1, wherein said camera is a 360-degree camera for visibility in horizontal and vertical planes, and further wherein said camera having a lens selected from the group consisting of a spherical lens and a dual-lens panoramic lens for aerial imaging.

7. The fire rapid response aerial device of claim 6, wherein said camera having a frame rate of more than 30 fps for real-time video feed.

8. The fire rapid response aerial device of claim 7, wherein said camera is adapted to map obstacles selected from the group consisting of a tree, a power line, and another said autonomous aerial firefighting device to support collision avoidance and adaptive pathfinding.

9. The fire rapid response aerial device of claim 8, wherein said frame is a drone frame having a material selected from the group consisting of a carbon fiber and a fire-resistant composite alloy.

10. The fire rapid response aerial device of claim 1, wherein said autonomous aerial firefighting device is a plurality of said autonomous aerial firefighting devices wirelessly coupled with a control server through a network, and further wherein said control server is a central coordination hub for coordinating flight patterns of said plurality of said autonomous aerial firefighting devices.

11. The fire rapid response aerial device of claim 10, wherein said plurality of propellers maintain balance and vertical lift of said autonomous aerial firefighting device and enable yaw, pitch, and roll control of said autonomous aerial firefighting device.

12. The fire rapid response aerial device of claim 10, wherein each of said plurality of said autonomous aerial firefighting devices having a GPS module for real-time geolocation tracking and said coordinating flight patterns.

13. The fire rapid response aerial device of claim 12 further comprising a communication module, wherein said communication module having wireless communication between said plurality of said autonomous aerial firefighting devices and said control server.

14. A method of suppressing fire with a rapid response aerial device, the method comprising the steps of:
providing an autonomous aerial firefighting device having a frame, a plurality of propellers, an onboard tank, a nozzle, a camera, and a fire-retardant chemical, wherein said onboard tank containing said fire-retardant chemical for fire suppression;
directing a spray of said fire-retardant chemical with said nozzle;
autonomously actuating said nozzle when said autonomous aerial firefighting device reaches a fire target location, wherein said nozzle having an adjuster for direct targeting of said fire-retardant chemical;
wherein said autonomous aerial firefighting device is a plurality of said autonomous aerial firefighting devices wirelessly coupled with a control server through a network;
wherein said control server is a central coordination hub for coordinating flight patterns of said plurality of said autonomous aerial firefighting devices;
wherein each of said plurality of said autonomous aerial firefighting devices having a GPS module for real-time geolocation tracking and said coordinating flight patterns;
wirelessly communicating with said plurality of said autonomous aerial firefighting devices and said control server; and
coordinating each of said plurality of said autonomous aerial firefighting devices for suppressing fire.

15. The method of suppressing fire with a rapid response aerial device of claim 14, wherein said coordinating of each of said plurality of said autonomous aerial firefighting devices is based on a condition selected from the group consisting of current fire dynamics, availability of said autonomous aerial firefighting device, and a level of said fire-retardant chemical.

16. A method of suppressing fire with a rapid response aerial device, the method comprising the steps of:
providing an autonomous aerial firefighting device having a frame, a plurality of propellers, an onboard tank, a nozzle, a camera, and a fire-retardant chemical, wherein said onboard tank containing said fire-retardant chemical for fire suppression;
directing a spray of said fire-retardant chemical with said nozzle;
autonomously actuating said nozzle when said autonomous aerial firefighting device reaches a fire target location, wherein said nozzle having an adjuster for direct targeting of said fire-retardant chemical;
wherein said autonomous aerial firefighting device is a plurality of said autonomous aerial firefighting devices wirelessly coupled with a control server through a network;
wherein said control server is a central coordination hub for coordinating flight patterns of said plurality of said autonomous aerial firefighting devices;
wherein each of said plurality of said autonomous aerial firefighting devices having a GPS module for real-time geolocation tracking and said coordinating flight patterns;
wirelessly communicating with said plurality of said autonomous aerial firefighting devices and said control server;
coordinating each of said plurality of said autonomous aerial firefighting devices for suppressing fire;
discharging said fire-retardant chemical from said plurality of said autonomous aerial firefighting devices; and
replenishing said fire-retardant chemical of each of said plurality of said autonomous aerial firefighting devices.

17. The method of suppressing fire with a rapid response aerial device of claim 16, wherein said coordinating of each of said plurality of said autonomous aerial firefighting devices is based on a condition selected from the group consisting of current fire dynamics, availability of said autonomous aerial firefighting device, and a level of said fire-retardant chemical.

18. The method of suppressing fire with a rapid response aerial device of claim 17, further comprising the steps of: dividing a fire zone into a plurality of assigned sectors based on latitude and longitude details of the fire zone and synchronizing a pattern of said plurality of said autonomous aerial firefighting devices to collectively suppress the fire.

19. The method of suppressing fire with a rapid response aerial device of claim 18, wherein said replenishing of said fire-retardant chemical includes a return to a designated replenishing area when said fire-retardant chemical reaches a predefined threshold.

20. The method of suppressing fire with a rapid response aerial device of claim 18, wherein said replenishing of said fire-retardant chemical includes an autonomous return to a designated replenishing area upon depletion of said fire-retardant chemical in each of said plurality of said autonomous aerial firefighting devices.
